(19) United States
(12) Patent Application Publication
(10) Pub. No.: US 2012/0054373 A1
(43) Pub. Date: Mar. 1, 2012

(54) Connection Apparatus, and Method Used in Connection Apparatus

(75) Inventor: Yoshiteru Tamura, Nagoya-shi (JP)

(73) Assignee: BUFFALO INC., Nagoya-shi (JP)

(21) Appl. No.: 13/214,247

(22) Filed: Aug. 22, 2011

(30) Foreign Application Priority Data
Aug. 24, 2010 (JP) 2010-186946

(51) Int. Cl. G06F 3/00

(52) U.S. Cl. 710/14

(57) ABSTRACT

The present invention provides a connection apparatus for connecting with at least one peripheral device and at least one host machine, the connection apparatus comprising: a first connection section connectable by a first communications standard to a host machine; at least one second connection section connectable by the first communications standard to a peripheral device; a communication section connectable by a second communications standard to a host machine via a network; a conversion section for inter-converting data between a data format compliant with the first communications standard and a data format compliant with the second communications standard; and a switching section for switching operational state of the connection apparatus between a first operational state in which a peripheral device connected to the at least one second connection section and a host machine connected to the communication section are data-communications enabled by means of data-format conversion by the conversion section, and a second operational state in which a peripheral device connected to the at least one second connection section and a host machine connected to the communication section are enabled for data communications in the data format compliant with the first communications standard.

### CROSS REFERENCE TO RELATED APPLICATION

The disclosure of Japanese Patent Application No. 2010-186946, filed on Aug. 24, 2010, is incorporated herein by reference.

### BACKGROUND OF THE INVENTION

1. Field of the Invention

The present invention relates to connection apparatuses that connect to peripheral devices and host machines to enable communication between the peripheral devices and host machines.

2. Description of the Background Art

In recent years, USB (universal serial bus) device servers have been attracting attention (for example, see Japanese Laid-Open Patent Publication No. 2008-048048). USB device servers are connected with USB devices and, via a network such as a LAN, are also connected to computers (host machines). USB device servers convert communications data between USB-standard compliant protocols and IP packet protocols, by using so-called USB over IP (internet protocol) technology, thereby enabling communications between computers and USB devices. In situations where a host machine and a USB device are connected via a USB cable, the distance between the host machine and the USB device is limited because of voltage reduction and signal delay due to the USB cable. But by using a USB device server, the advantage is that limitations, due to USB cables, on placement distance can be eliminated. In addition, since a USB device server carries out IP packet exchanges via, for example, a LAN, a plurality of host machines that connect to the LAN can share a USB device.

Nevertheless, with conventional USB device servers, even in situations where USB devices and host machines are arranged close to each other, deterioration in communication quality can occur due to drop in communications rate, frame losses, etc. owing to, for example, the LAN. In addition, with transmission rates in communications via a LAN or similar network not equaling transmission rates in communications compliant with USB standards, data transmission rates are in some cases slowed.

That is, with conventional USB device servers, although on the one hand limitations, originating in USB cables, on distance between a host machine and a USB device are eliminated, on the other there is a risk that deterioration, originating in the network, in communication quality cannot be stopped.

It will be appreciated that such problems are not limited to USB device servers but are common to all connection apparatuses that connect to peripheral devices and enable communications between the peripheral devices and host machines connected via a network.

### SUMMARY OF THE INVENTION

The present invention has been made to solve at least a part of the conventional problems described above, and an object of the present invention is to provide a convenient connection apparatus that is capable of switching its operation state between a mode in which a plurality of host machines can share a peripheral device without restriction of distance between the peripheral device and the plurality of host machines, and a mode in which a high-speed communication between a host machine and a peripheral device is realized.

The first aspect of the present invention is a connection apparatus for connecting with at least one peripheral device and at least one host machine, the connection apparatus comprising: a first connection section connectable by a first communications standard to a host machine; at least one second connection section connectable by the first communications standard to a peripheral device; a communication section connectable by a second communications standard to a host machine via a network; a conversion section for inter-converting data between a data format compliant with the first communications standard and a data format compliant with the second communications standard; and a switching section for switching operational state of the connection apparatus between a first operational state in which a peripheral device connected to the at least one second connection section and a host machine connected to the communication section are data-communications enabled by means of data-format conversion by the conversion section, and a second operational state in which a peripheral device connected to the at least one second connection section and a host machine connected to the communication section are enabled for data communications in the data format compliant with the first communications standard.

Preferably, the connection apparatus may further comprise a detection section for detecting that a host machine has been connected to the first connection section. The switching section may, when the detection section has detected that a host machine has been connected to the first connection section, switch the operational state from the first state to the second state.

Preferably, the connection apparatus may comprise a plurality of the communication sections, and the communication sections may be connectable to a host machine by, as the second communications standard, respective communications standards that differ from each other.

Preferably, the first communication standard may be a USB standard.

The second aspect of the present invention is a communications method executed by a connection apparatus for connection to at least one peripheral device and at least one host machine, the communications method comprising: a step of making connection to a host machine by a first communications standard or a network-routing second communications standard; a step of making connection to a peripheral device by the first communications standard; a step of inter-converting data between a data format compliant with the first communications standard and a data format compliant with the second communications standard; and a step of switching operational state of the connection apparatus between a first operational state in which a peripheral device, and a second-communications-standard connected host machine, are data-communications enabled by means of data-format conversion in the step of inter-converting data, and a second operational state in which a peripheral device and a first-communications-standard connected host machine are enabled for data communications in the data format compliant with the first communications standard.

It should be noted that the present invention can be realized in a variety of modes. For example, the present invention can be realized as a connection method, a connection apparatus, or a connection system for a peripheral device; an integrated circuit or a computer program for realizing such a method or the function of such an apparatus; or a storage medium having stored therein the computer program.

According to the present invention, it becomes possible to provide a convenient connection apparatus that is capable of switching its operation state between a mode in which a plurality of host machines can share a peripheral device without restriction of distance between the peripheral device and the plurality of host machines, and a mode in which a high-speed communication between a host machine and a peripheral device is realized.

The present invention is useful for a device server or the like that relays data between a peripheral device and a host machine. In addition, the present invention is useful for an information processing system or the like including such apparatuses. These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a connection apparatus according to a first embodiment of the present invention, and a peripheral device and a host machine connected to the connection apparatus;

FIG. 2 is a diagram showing the internal configuration of the connection apparatus according to the first embodiment of the present invention as it is in a “device server mode”;

FIG. 3 is a flowchart showing processes performed by the connection apparatus according to the first embodiment of the present invention;

FIG. 4 is a diagram showing the internal configuration of the connection apparatus according to the first embodiment of the present invention as it is in a “hub mode”; and

FIG. 5 is a diagram showing the internal configuration of a connection apparatus according to a second embodiment of the present invention.

### DESCRIPTION OF THE PREFERRED EMBODIMENTS

### First Embodiment

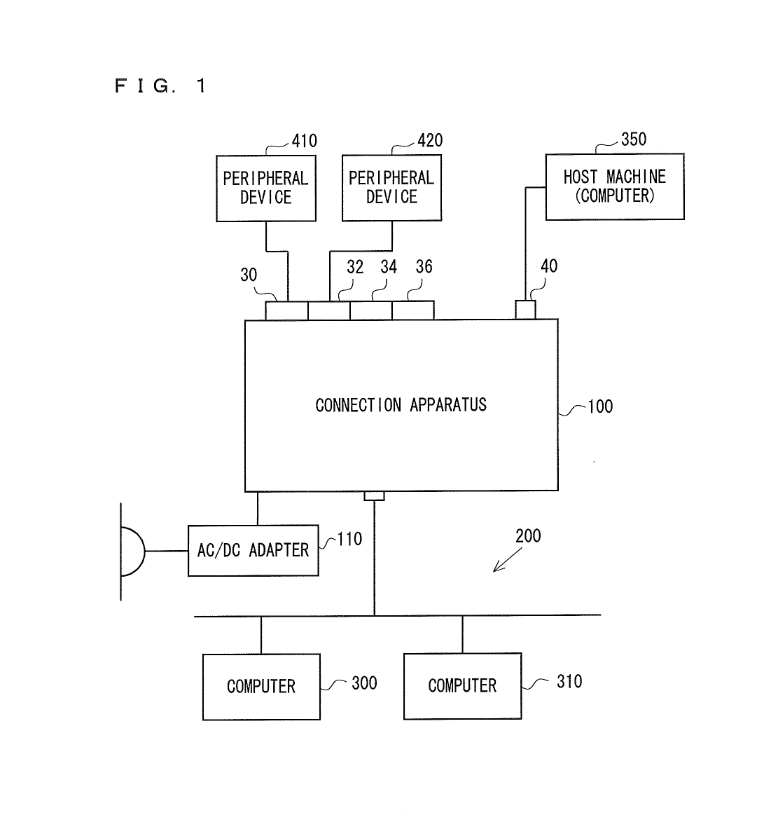

FIG. 1 is a diagram showing a connection apparatus 100 according to the first embodiment of the present invention, and a peripheral device and a host machine connected to the connection apparatus 100. A plurality of peripheral devices can be connected to the connection apparatus 100. The connection apparatus 100 has operational states a “device server mode” and a “hub mode.” It should be noted that the connection apparatus 100 is supplied with power from an AC/DC adapter 110.

In the “device server mode,” a computer that is a host machine can communicate, via a network, with a peripheral device connected to a downstream port (second connection section) of the connection apparatus 100. The downstream port is a port to which a peripheral device for the connection apparatus 100 is to be connected. In the example shown in FIG. 1, computers 300 and 310 can communicate, via a network, with peripheral devices 410 and 420 connected to downstream ports 30 and 32 of the connection apparatus 100. In the present embodiment, as an example, a network 200 is a LAN (local area network), and the peripheral devices 410 and 420 are USB devices.

In the “device server mode,” the connection apparatus 100 communicates with the computers 300 and 310, based on IP (Internet Protocol) (second communication standard) as an example, and communicates with the USB devices 410 and 420, based on the USB 2.0 standard (first communication standard) as an example. That is, the connection apparatus 100 realizes the “device server mode” by using a technique of “USB Over IP.” It should be noted that data transfer methods used in communications compliant with the USB 2.0 standard include the four transfer methods control transfer, bulk transfer, interrupt transfer, and isochronous transfer.

In the “hub mode,” a computer which is a host machine, connected to an upstream port of the connection apparatus 100, can communicate with a USB device connected to the downstream port of the connection apparatus 100. The upstream port is a port, of the connection apparatus 100, to which a host machine is to be connected. In the example shown in FIG. 1, a computer 350 connected to an upstream port 40 (first connection section) of the connection apparatus 100 can communicate with the USB devices 410 and 420 connected to the downstream ports 30 and 32 of the connection apparatus 100. In the “hub mode,” the computer 350 communicates with the USB devices 410 and 420, based on USB 2.0 standard as an example.

In the case where the computer 350 which is a host machine is not connected to the upstream port 40 of the connection apparatus 100, the connection apparatus 100 operates in the “device server mode.” On the other hand, in the case where the computer 350 which is a host machine is connected to the upstream port 40 of the connection apparatus 100, the connection apparatus 100 operates in the “hub mode.”

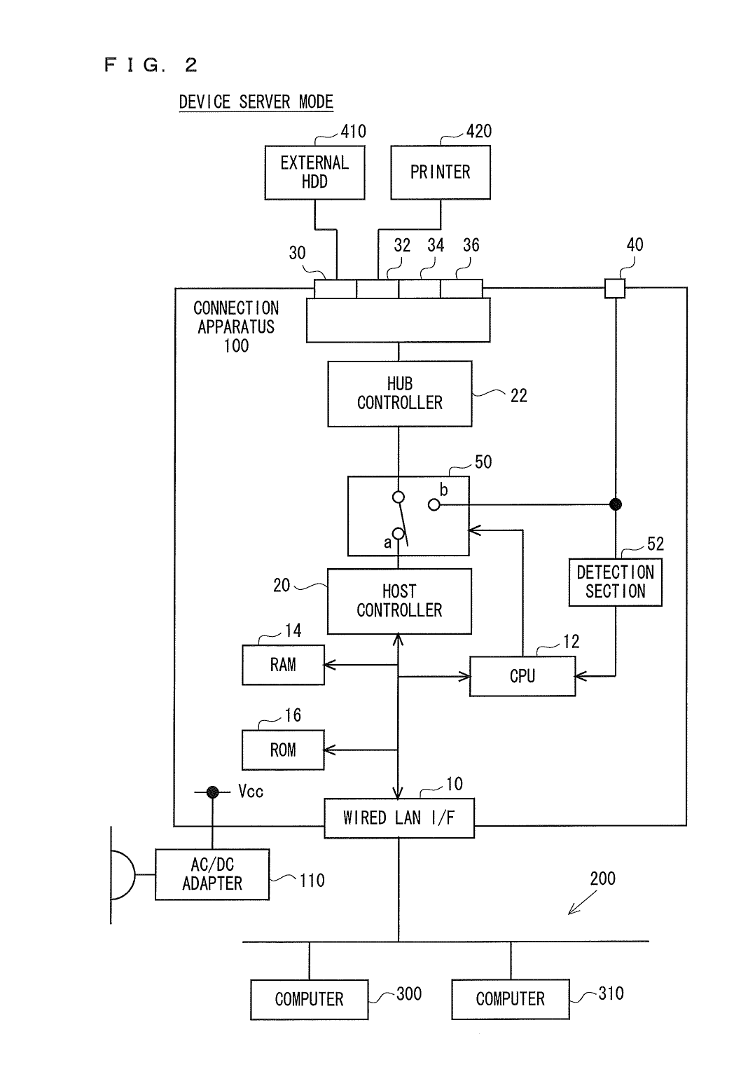

FIG. 2 is a diagram showing the internal configuration of the connection apparatus 100 as it is in the “device server mode.” In FIG. 2, a computer which is a host machine is not connected to the upstream port 40 of the connection apparatus 100. Therefore, the connection apparatus 100 operates in the “device server mode.”

In order to realize a function in the “device server mode,” the connection apparatus 100 includes a wired LAN interface 10, a CPU 12, a RAM 14, a ROM 16, a host controller 20, a hub controller 22, and four downstream ports 30, 32, 34, and 36. For example, as a USB device, an external hard disk drive (HDD) 410 of a USB connection type, or a printer 420 of a USB connection type is connected to the downstream ports 30, 32, 34, and 36.

In order to realize a function in the “hub mode,” the connection apparatus 100 further includes an upstream port 40 to which a host machine is to be connected. In addition, the connection apparatus 100 includes a switch 50 which is a switching section for switching the operational state between the “device server mode” and the “hub mode,” and a detection section 52 for detecting that a host machine has been connected to the upstream port 40.

In an example shown in FIG. 2, the switch 50 is set in a position a, whereby the hub controller 22 and the host controller 20 are connected to each other. Therefore, the connection apparatus 100 operates in the “device server mode.” It should be noted that for example, a transistor or a relay may be employed as the switch 50.

For example, the hub controller 22 detects that a USB device is connected, detects a communication rate, converts a communication rate, distributes a signal, and manages supply of power to a USB device. The host controller 20 controls a variety of USB devices connected to the downstream ports 30, 32, 34, and 36.

The CPU 12 loads a program stored in the ROM 16 into the RAM 14, and executes the program, to perform various controls for the components of the connection apparatus 100. Specifically, for example, the CPU 12 functions as a conversion section for converting (encapsulating) data compliant with USB standard, received from a USB device, into an IP packet, and for converting an IP packet received from the wired LAN interface 10, into data compliant with USB standard, which can be received by a USB device. In addition, the CPU 12 switches the switch 50, based on a notification from the detection section 52 as described later.

The wired LAN interface 10 (communication section) is connected to the LAN 200 via a LAN cable. The wired LAN interface 10 is a communication section that can communicate with computers 300 and 310 connected to the LAN 200. Specifically, the wired LAN interface 10 encapsulates an IP packet to generate a MAC frame, and transmits a MAC frame having stored therein an IP packet to the computers 300 and 310 or receives such an IP packet from the computers 300 and 310.

The detection section 52 detects that the computer 350 which is a host machine is connected to the upstream port 40. Specifically, the detection section 52 monitors whether or not polling is performed in a data terminal of the upstream port 40, thereby determining whether or not the computer 350 is connected to the upstream port 40. If the detection section 52 has detected that the computer 350 is connected to the upstream port 40, the detection section 52 notifies the CPU 12 of the connection.

When the CPU 12 has received the notification from the detection section 52, the CPU 12 switches the switch 50 from the position a to a position b, thereby switching the operational state of the connection apparatus 100 to the “hub mode.” In the “hub mode,” the hub controller 22 is connected to the upstream port 40.

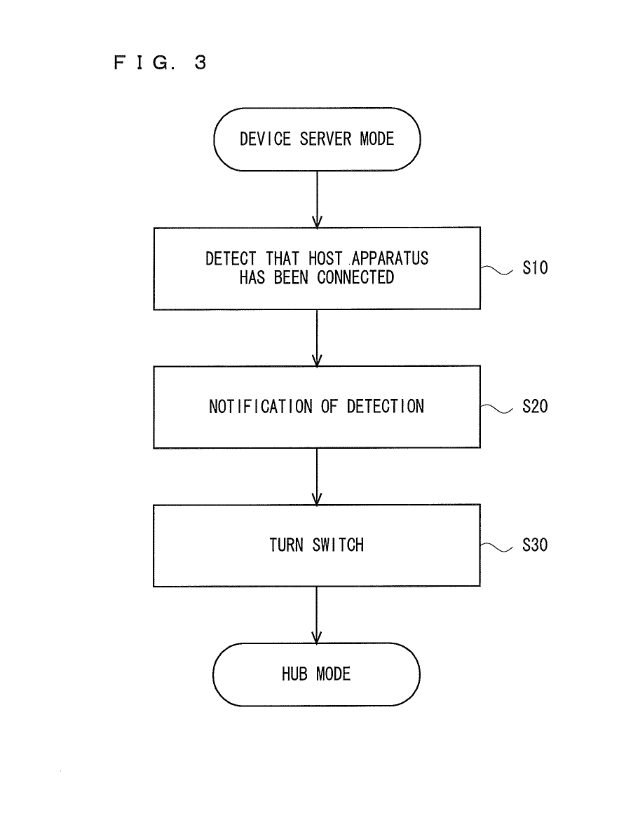

FIG. 3 is a flowchart showing processing performed by the connection apparatus 100 in the case where a host machine is connected to the upstream port 40. When the operational state of the connection apparatus 100 is the “device server mode,” if a host machine has been connected to the stream port 40, the detection section 52 detects that the host machine has been connected (step S10).

In step S20, the detection section 52 notifies the CPU 12 that the connection of the host machine has been detected. If the CPU 12 receives the notification from the detection section 52, the CPU 12 switches the switch 50 from the position a to the position b (step S30). If the switch 50 has been switched in this way, the operational state of the connection apparatus 100 becomes the “hub mode.”

It should be noted that in step S30, the CPU 12 monitors communication between a USB device and a host controller 20. Then, if the USB device and the host controller 20 are in communication with each other, the switch 50 may be switched after the communication is finished, instead of immediately switching the switch 50. In this way, it becomes possible to suppress occurrence of trouble due to interruption of communication between the USB device and the host controller 20.

In addition, if the detection section 52 has detected that the connection between the computer 350 which is a host machine, and the upstream port 40 has been terminated, the detection section 52 notifies the CPU 12 that the connection has been terminated. When the CPU 12 has received the notification from the detection section 52, the CPU 12 switches the switch 50 from the position b to the position a, thereby switching the operational state of the connection apparatus 100 to the “device server mode.” In the “device server mode,” the hub controller 22 is connected to the host controller 20.

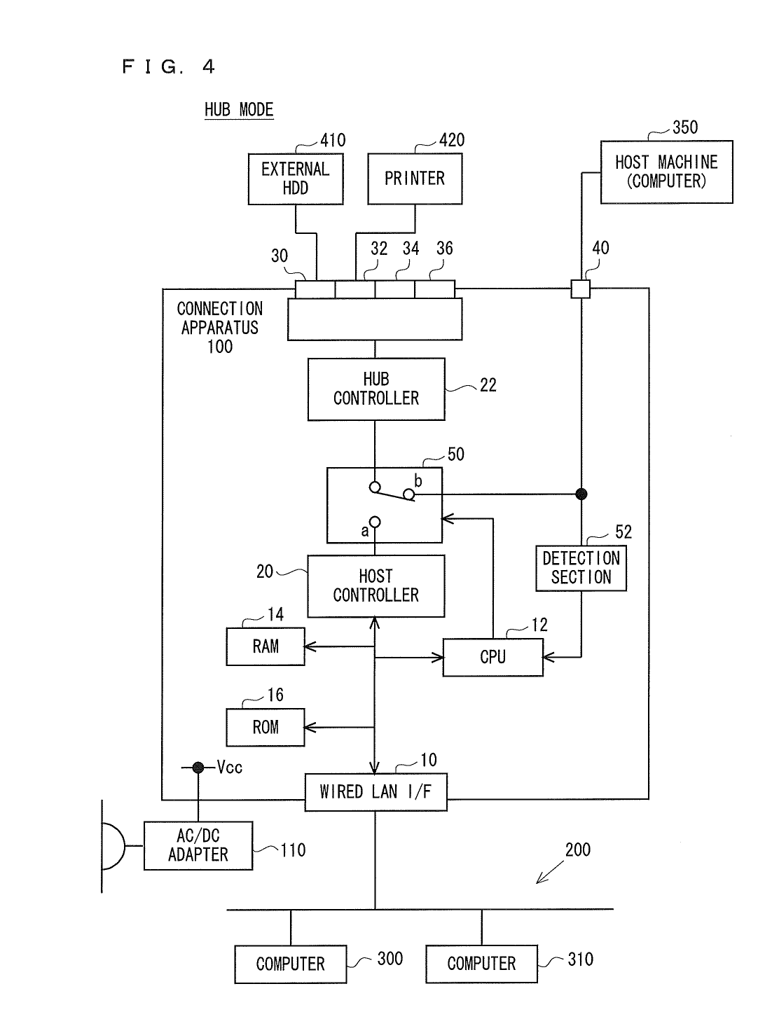

FIG. 4 is a diagram showing the internal configuration of the connection apparatus 100 as it is in the “hub mode.” In the “hub mode,” the computer 350 functions as a host of a USB device. The computer 350 can communicate with a variety of USB devices connected to the downstream ports 30, 32, 34, and 36, based on, for example, USB 2.0 standard.

As described above, in the case where a computer is not connected to the upstream port 40, the connection apparatus 100 operates in the “device server mode,” and in the case where a computer is connected to the upstream port 40, the connection apparatus 100 operates in the “hub mode.”

If it is desired that a plurality of computers share a USB device via a network, that is, it is desired that a plurality of computers can communicate with a USB device, a user may connect the plurality of computers to the wired LAN interface 10 instead of the upstream port 40, and may use the connection apparatus 100 in the “device server mode.”

On the other hand, if it is desired that for example, high-speed communication compliant with USB 2.0 standard is realized between a computer and a USB device, a user may connect the computer to the upstream port 40, and may use the connection apparatus 100 in the “hub mode.” For example, if it is desired to write a large amount of data in an external hard disk or a Blu-ray (registered trademark) disk drive in a short time, a user may connect a computer to the upstream port 40, and may use the connection apparatus 100 in the “hub mode.”

As described above, according to the first embodiment, it is possible to provide a more convenient connection apparatus that is capable of switching its operational state between a mode in which a plurality of host machines share a peripheral device via a network, and a mode in which a high-speed communication between a host machine and a peripheral device is realized without a network therebetween. In addition, the connection apparatus automatically switches the operational state in accordance with whether a host machine is connected to an upstream port or a wired LAN interface, thereby enhancing its convenience.

### Second Embodiment

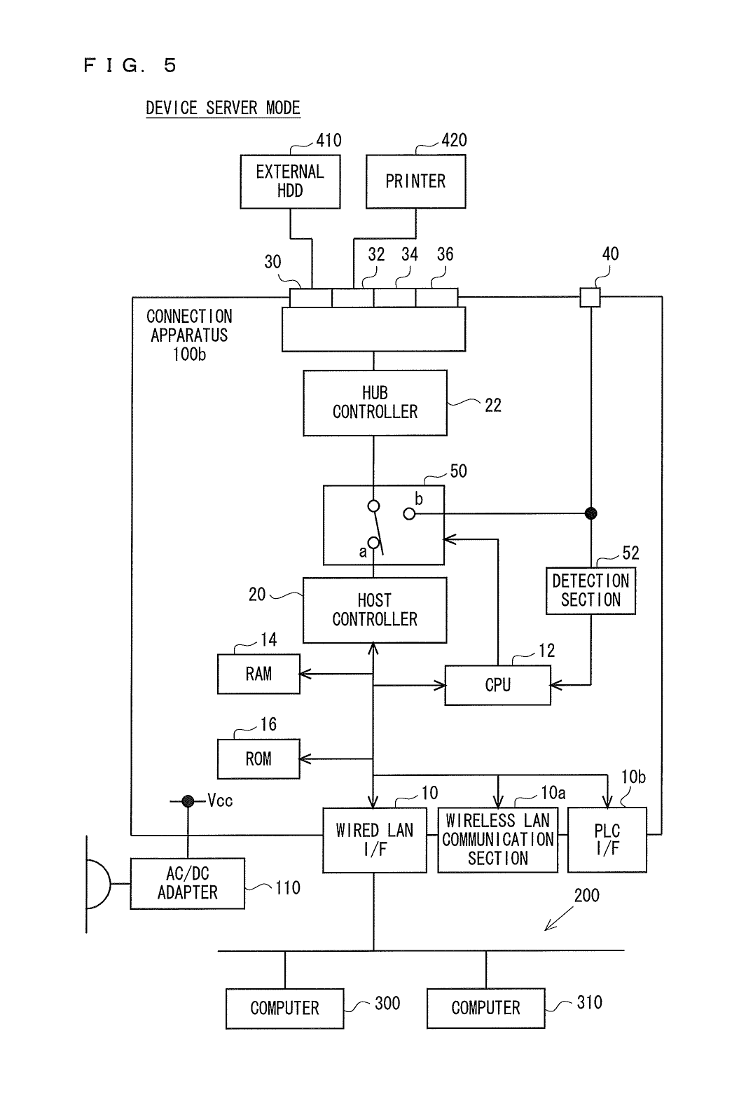

FIG. 5 is a diagram showing a connection apparatus 100b according to the second embodiment of the present invention, the internal configuration thereof, and a peripheral device and a host machine connected to the connection apparatus 100b. The connection apparatus 100b is different from the connection apparatus 100 according to the first embodiment shown in FIG. 1 only in that, besides the wired LAN interface 10, a wireless LAN communication section 10a and a PLC (power line communication) interface 10b are provided as interfaces for making connection with a computer in the “device server mode.” The other part of configuration is the same as that of the connection apparatus 100. The connection apparatus 100b can be connected to a computer in plural types of communication methods. Therefore, the convenience is further improved. In addition, the connection apparatus 100b may use plural types of communication methods at the same time, thereby improving the communication rate.

It should be noted that the present invention is not limited to the above embodiments. The present invention can be implemented in various modes without departing from the scope of the invention. For example, the following modifications are possible.

(Modification 1)

In the above embodiments, the detection section 52 monitors the data terminal of the upstream port 40, and detects that a computer which is a host machine is connected to the upstream port 40. Instead, the detection section 52 may monitor another electric signal in the upstream port 40.

For example, the detection section 52 may monitor a power supply voltage VBUS of a power supply terminal of the upstream port 40. In addition, a switch for mechanically detecting whether or not a computer which is a host machine has been connected, or a photo-interrupter for optically detecting the same may be provided to the upstream port 40.

(Modification 2)

In the above embodiments, the detection section 52 detects that a computer which is a host machine has been connected to the upstream port 40 or that the connection has been terminated, and the CPU 12 controls the switch 50, whereby the operational state is automatically switched between the “device server mode” and the “hub mode.” Instead, an instruction to switch the operational state may be received from a user, and the operational state may be switched between the above modes in accordance with the instruction.

(Modification 3)

In the above embodiments, USB 2.0 standard is used as the communication standard of peripheral devices, as an example. In the present invention, other USB standards such as USB 1.0 standard, USB 1.1 standard, or USB 3.0 standard may be used. In addition, the present invention is also applicable to connection apparatuses compliant with other communication standards such as an IEEE (The Institute of Electrical and Electronic Engineers) 1394 or an eSATA (external Serial ATA).

In addition, communication between the connection apparatus 100 and a host machine in the “device server mode” may be realized by communication standards other than TCP/IP. Communication standards other than TCP/IP include, for example, AppleTalk (registered trademark), IPX (Netware), NetBEUI, and DEC. In addition, the connection apparatus 100 may support such a plurality of communication standards. In this case, the CPU 12 converts the format of data in manners compliant with the respective communication standards used in communication between peripheral devices and host machines.

(Modification 4)

In the above embodiments, the connection apparatus 100 includes four downstream ports. Instead, the connection apparatus 100 may include three or less downstream ports, or five or more downstream ports.

It should be noted that in the above embodiments, at least a part of the components of the connection apparatus may be realized by hardware or software.

What is claimed is:

1. A connection apparatus for connecting with at least one peripheral device and at least one host machine, the connection apparatus comprising:
a first connection section connectable by a first communications standard to a host machine;
at least one second connection section connectable by the first communications standard to a peripheral device;
a communication section connectable by a second communications standard to a host machine via a network;
a conversion section for inter-converting data between a data format compliant with the first communications standard and a data format compliant with the second communications standard; and
a switching section for switching operational state of the connection apparatus between a first operational state in which a peripheral device connected to the at least one second connection section and a host machine connected to the communication section are data-communications enabled by means of data-format conversion by the conversion section, and a second operational state in which a peripheral device connected to the at least one second connection section and a host machine connected to the communication section are enabled for data communications in the data format compliant with the first communications standard.

2. The connection apparatus according to claim 1, further comprising a detection section for detecting that a host machine has been connected to the first connection section; wherein:
the switching section, when the detection section has detected that a host machine has been connected to the first connection section, switches the operational state from the first state to the second state.

3. The connection apparatus according to claim 1, comprising a plurality of the communication sections; wherein:
the communication sections are connectable to a host machine by, as the second communications standard, respective communications standards that differ from each other.

4. The connection apparatus according to claim 1, wherein the first communications standard is a USB standard.

5. A communications method executed by a connection apparatus for connection to at least one peripheral device and at least one host machine, the communications method comprising:
a step of making connection to a host machine by a first communications standard or a network-routing second communications standard;
a step of making connection to a peripheral device by the first communications standard;
a step of inter-converting data between a data format compliant with the first communications standard and a data format compliant with the second communications standard; and
a step of switching operational state of the connection apparatus between a first operational state in which a peripheral device, and a second-communications-standard connected host machine, are data-communications enabled by means of data-format conversion in the step of inter-converting data, and a second operational state in which a peripheral device and a first-communications-standard connected host machine are enabled for data communications in the data format compliant with the first communications standard.
